(19) United States
(12) Patent Application Publication
(10) Pub. No.: US 2009/0053514 A1
(43) Pub. Date: Feb. 26, 2009

(54) OFFSET PRINTING BLANKET AND METHOD FOR MAKING SAME

(75) Inventors: Denis Hertzog, Berrwiller (FR); Sophie Haraux, Aspach Le Haut (FR); Marc Than, Roissy En France (FR); Hubert Justine, Busque (FR); Jerzy Kuczynski, Zillisheim (FR)

Correspondence Address: LEYDIG VOIT & MAYER, LTD, 700 THIRTEENTH ST. NW, SUITE 300, WASHINGTON, DC, 20005-3960, US

(73) Assignee: MACDERMID PRINTING SOLUTIONS EUROPE SAS, Cernay (FR)

(21) Appl. No.: 11/993,244

(22) PCT Filed: Jun. 22, 2006
(86) PCT No.: PCT/FR2006/001433

§ 371 Date: Jan. 8, 2008

(30) Foreign Application Priority Data
Jun. 23, 2005 (FR) 0506392

(51) Int. Cl. B41N 10/04; B32B 7/02

(52) U.S. Cl. 428/339; 428/141; 428/409; 264/175; 264/171.13

(57) ABSTRACT

The invention concerns an offset printing blanket. The blanket is of the type comprising an outer printing layer, an inner layer whereby the blanket is in contact with a support cylinder and at least one compressible intermediate layer. The blanket is characterized in that it comprises a printing layer (10) whereof the printing surface has very slight surface roughness (Ra) advantageously less than 0.4 micrometer. The invention is useful in the field of offset printing.

The invention concerns an offset printing blanket, of the type comprising an outer printing layer, an inner layer with which the blanket is in contact with a medium cylinder and at least one compressible intermediate layer, and a process for the production of such a blanket

It is known that existing blankets do not allow the offset-printing of certain media that have proven to be too fragile for the high printing pressures used in offset printing, with inks that are more viscous and more tacky, and due to the presence of water which is necessary for ensuring the separation of the image on the plate. The high printing pressure brings about extensive mechanical stresses on the paper which is rolled in the regions of contact, and the tacky effect of the inks exerts mechanical stresses coming out of the printing nip tending to tear off the fibers and the layers of paper. The presence of a relatively large quantity of water necessary for ensuring the equilibrium of the offset process brings about deterioration of the integrity of the paper above all for four-color process prints in which the medium is subjected to a number of passages in the successive printing stations with the intake of water with each passage through the nip and potentially on each side of it.

Consequently, special papers are used for offset printing, which increases the costs on the order of 20 to 30% with respect to media used in heliogravure and flexography, and constitutes a considerable drawback given the cost burden of the medium in the final production cost for printed matter such as magazines or advertising brochures.

The objective of the present invention is to propose an offset printing blanket which alleviates the drawbacks of the known blankets.

In order to realize this objective, the offset printing blanket according to the invention is characterized by the fact that it has a printing layer whose printing surface has a very low average surface roughness Ra between 0.2 and 0.4 μm.

According to one characteristic of the invention, the printing side of the printing layer is a side of a layer obtained by calendering or extrusion and calendering on a blanket carcass containing all the layers except the printing layer, against a very smooth surface.

According to another characteristic of the invention, the very smooth surface is the peripheral surface of a mirror-finished metallic cylinder of the calender.

According to yet another characteristic of the invention, the very smooth surface is the surface of a printing layer obtained by extrusion and calendering in the nip of a calender against a film of a surface with a very low roughness value.

According to yet another characteristic, the aforementioned film is maintained on the printing side of the printing layer and serves as protective film.

The invention will be better understood, and other of its objectives, characteristics, details and advantages will appear more clearly in the following explanatory description in reference to the appended schematic drawings given only by way of example illustrating several embodiments of the invention and in which:

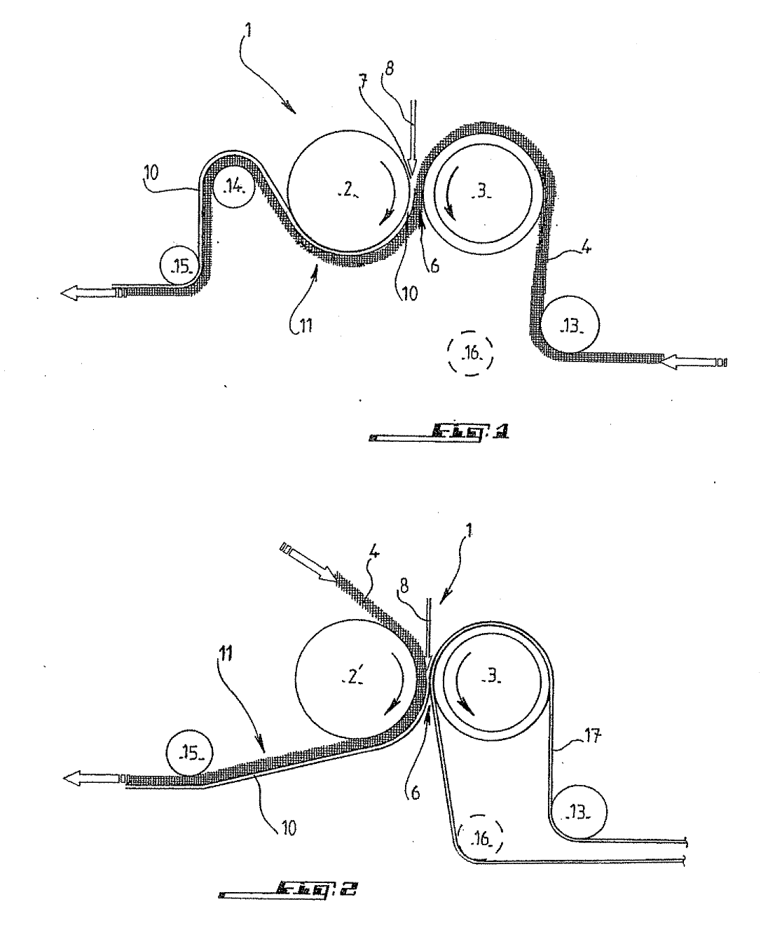

FIG. 1 is a schematic view illustrating the device for production of a printing blanket according to the invention by extrusion and calendering;

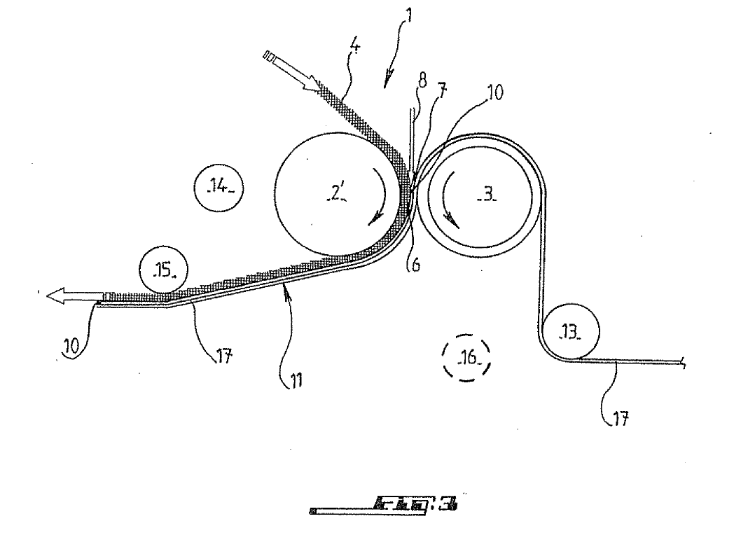

FIG. 2 is a schematic view of another embodiment of a printing blanket according to the invention by extrusion and calendering, and

FIG. 3 is a schematic view illustrating a different version of the device of FIG. 2.

FIG. 1 illustrates a first embodiment of an offset printing blanket according to the invention, which involves the use of calender device 1 essentially comprising a first cylinder made of metal with a mirror finish, whose temperature is advantageously adjustable, designated by reference 2, and second cylinder 3 whose surface has a covering, between which runs strip 4 constituting the carcass of the blanket, the strip having all the layers with the exception of the printing layer which is produced by extrusion in nip 6 between two cylinders 2 and 3, more precisely in the interval in the nip delimited between carcass 4 and cylinder 2, as represented by arrow 8. During passage through the nip of the two cylinders, which in a known manner turn synchronously in opposite directions of rotation, the printing layer noted 10 is calendered on carcass 4. Consequently, the blanket is formed at the outlet of calender 1. Given that the printing layer is formed in contact with cylinder 2 on the outer surface that is finished, that is, with a very high outer surface quality, so as to have the surface quality of a mirror, the outer surface of printing layer 10 has the required very smooth surface quality. It should be noted that the carcass runs by guide roller 13 upstream from calender 1 is [sic; and] downstream, successively over two guide rollers 14 and 15. The device also has a fourth roller designated 16, but which is not used in the case of FIG. 1.

FIG. 2 illustrates another manufacturing method of blanket according to the invention, using calender 1, which as in the case of FIG. 1 has two cylinders, one of which, namely cylinder 3, could be identical to cylinder 3 of FIG. 1, while the other cylinder, now designated by the reference 2′, is a metallic cylinder, whose temperature can be adjusted if necessary, whose surface need not be finished nor have the qualities of the surface of cylinder 2 of FIG. 1. According to the process of FIG. 2, printing layer 10 is now obtained by extrusion in [nip] 6 of the calender between carcass 4 and film 17 which runs through nip 6 around cylinder 3 and guide rollers 13 and 16. On the downstream side, blanket 11 with printing layer 10 now calendered on carcass 4 runs over transport roller 15.

This embodiment presents the advantage that it is no longer the surface of one of the cylinders that must have specific required surface qualities, but rather the surface against which the printing layer is molded is the surface of film 17.

FIG. 3 illustrates a variant of the process according to FIG. 2 whose particularity lies in the fact that film 17 remains applied to the printing side which has been molded beforehand by this film in nip 6 of the calender and serves as protection for this printing side.

Thanks to the printing or transfer surface of the outer layer with clearly less surface roughness in comparison with known blankets, it is characterized by a low measured roughness coefficient Ra typically less than 0.4 μm, and because of the absence of micro-irregularities on the surface, which in the case of the known blankets form points for catching the fibers and of the layer of the printed substrate, the blanket according to the invention also enables the printing of fragile substrates and provides a qualitative jump in printing and increased printing ease for the conventional substrates used in offset printing.

The printing surface according to the invention extends the spectrum of use of the offset process to new paper media, packing cardboards and synthetic films, opening new possibilities in terms of benefits, certain media being less expensive and their use providing printers with considerable competitive advantages. Furthermore, as just stated, the traditional media already printed and offset printed are also printed with a greater level of quality, with more ease or reliability with blanket according to the invention.

The advantage of the invention has been concretely demonstrated by printing 70 g/m² helio paper, layered and calendered, pre-cut to the format of a machine known as Speedmaster 52 having two in-line printing stations. The comparative testing was done with two blankets with essentially the same carcass and same thickness; the one noted A having a ground elastomer-type surface and the other noted B having a surface according to the invention, the known blanket being of the type marketed under the trade name STX 207 by the applicant.

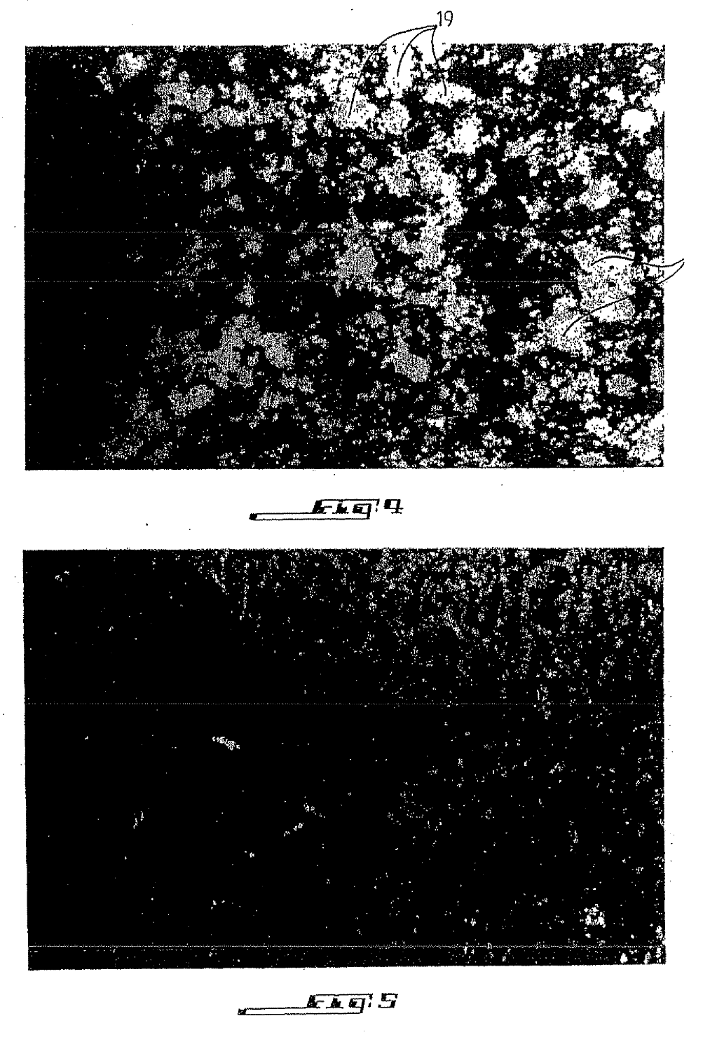

With known blanket A and the selected paper it proved impossible to obtain even a single-color print of acceptable quality corresponding to a single passage through in the nip of the printing machine. FIG. 4, according to a photograph of a solid [ink] area illustrating the print made and magnified 100×, shows that the printed paper has been irreversibly damaged by passage through the nip. One observes in particular the tearing on the surface of the printed paper layer in patches indicated as 19, which make the print defective. Furthermore, these torn parts accumulate on the blanket and consequently bring about additional increasing deterioration of the future printing.

In contrast, the blanket according to the invention enabled one to obtain a print which reproduced correctly a solid area without tearing, as shown by FIG. 5, also to a photograph magnified 100×.

The following table gives the result of the comparison of the measurements made using a roughness tester on known blankets A and blankets B according to the invention.

| | \textcircled{2} Rugosité Ra | \textcircled{3} PC (nombre de pics |
|---|---|---|
| \textcircled{1} Blanchet | (en μm) | en cm⁻¹) |
| \textcircled{4} Type A | 1.24 | 105 |
| \textcircled{5} Type B (selon | 0.33 | 21 |
| l'invention) | | |

Key:
\textcircled{1} Blanket
\textcircled{2} Roughness Ra (in μm)
\textcircled{3} PC (number of peaks in cm⁻¹)
\textcircled{4} Type A
\textcircled{5} Type B (according to the invention)

The average surface roughness and the number of peaks were measured by roughness testers of the Perthomètre type of the company Mahr and according to the standards DIN 4768 or ISO 4287 or Euronorm 49 ANSI/ASME B 46.1 and related standards.

It thus proved possible in the tests to reduce considerably wetting of the machine, which allowed the paper to keep its integrity, and also to obtain an excellent relaxation of the paper exiting the nip, with the mechanical stresses on the medium reduced to a minimum.

It should be noted that the expert in the field would naturally be dissuaded from looking in the direction of a blanket that is smoother on the surface as is the case for the invention, because it is generally accepted professionally that a blanket of this type has a poor paper relaxation which will run counter to what is needed for the type of paper or substrate that one wishes to print or is able to print with the present invention. What is observed in the case of the blanket according to the invention is therefore a surprising effect undoubtedly connected with the morphology of the surface and with the process used to obtain it. The blankets of the known state of the art very generally have roughness values of the type of those of the blanket of type A of this example.

The advantages provided by the blanket according to the invention are explained by the fact that the printing surface with reduced roughness according to the invention creates much more favorable operating conditions in comparison with known blankets, particularly a reduction of the quantities of water present on the blanket and transmitted to the medium, with the inking found to be reduced in similar proportion, because of the great transfer capability of the printing surface.

The considerably improved relaxation of the medium exiting the nip is explained by the fact that the printing surface according to the invention reduces the forces of delamination of the film of printing ink, sparing the integrity of the paper In this regard, it should be noted that the inks ordinarily used in offset printing have high viscosities in comparison with the inks of other processes, such as photogravure or flexography, which affects the printing behavior, the separation of the sheet of paper from the blanket leaving the printing nip requiring delamination of the film of ink which mechanically stresses the substrate and particularly the paper layers, which can be fragile.

With regard to the physical properties possessed by the printing surface of blanket according to the invention, the polymers constituting these surfaces are characterized by suitable elastomer properties of rubber-like type, a tensile Young's modulus between 3 and 20 MPa, chemical resistance, that is, limited swelling and weight loss in the presence of fluids, which is compatible with the offset printing process and greasy inks or inks crosslinked by radiation, and by polar or apolar surface energies in a window allowing a perfect water/ink balance and a high degree of ink transfer.

As an example regarding the numerical data and the nature of the printing layer of blanket according to the invention, this layer has a thickness between 0.15 mm and 0.8 mm, the dispersive (apolar) surface energy component is between 15 and 30 mJ/m², the polar surface energy component is between 0 and 20 mJ/m², and the average surface roughness Ra is less than 0-4 μm.

The printing surface is advantageously produced with elastomer materials of any type that is compatible with offset printing, such as polymers known under the terms EPDM, IIR, NBR, HNBR, XNBR, SBR, AU, TPU, PE-Co-O, SEBS or more generally S-x-S, ACM and PAC, VKM and FKM and the pertinent combinations. Concerning the molding and protective film, it could be PET, PC, PBT or the like, with a treated surface condition or made of glossy coated paper or the like.

It emerges from the preceding that in order to obtain the high-quality printing surface required for the invention, any process enabling one to obtain such a surface with a very low roughness value and with no irregularities can be used. It is advantageous to produce the printing layer or film on the printing surface according to the invention by calendering, by extrusion and calendering or casting in a calender nip against a cylinder with an appropriate surface morphology, such as a finished surface, according to FIG. 1. As shown by FIGS. 2 and 3, it would also be possible to produce the printing surface according to the invention by calendering or extruding the layer in the nip of a calender against a protective film of which the condition of one of its sides enables one to generate the extremely smooth surface with no irregularities required for the printing blanket. The molding film could be used for protection of the printing surface from any deterioration or alteration during the production steps that follow and during handling operations before mounting on the printing machine.

The description just given shows that the printing surface with the stated elastomer properties is very advantageous inasmuch as it ensures a chemical resistance which is compatible with the fluids of offset processes and a surface morphology such that it allows a considerably improved transfer and a perfect relaxation of the substrate exiting the nip, guaranteeing the integrity of fragile substances. It is observed in particular that the invention ensures satisfactory printability for fragile media and enables one to obtain a qualitative jump in printing and increased ease of printing for the conventional substrates used in offset printing.

It should furthermore be noted that what is described here is only an example. Without deviating from the scope of the inventions the surface according to the invention can be calendered or extruded and then calendered on just a part of the carcass or even on just one material ply, and the production of the blanket can be subsequently completed with any known process.

1. An offset printing blanket comprising an outer printing layer, an inner layer with which the blanket is in contact with a medium cylinder, at least one compressible intermediate layer, and a printing layer having a printing surface with an average surface roughness Ra less than 0.4 μm; wherein the printing surface includes a polymer with rubber-like elastomer properties, a tensile Young's modulus between 3 and 20 MPa, and a chemical resistance compatible with an offset process and offset process fluids.

2. The blanket according to claim 1, wherein the printing surface of the printing layer has a surface roughness Ra between 0.2 and 0.4 μm.

3. The blanket according to claim 1, wherein the printing surface of the printing layer is a side of a layer obtained by extrusion of an elastomer material which is compatible with offset printing, which is molded against a very smooth molding surface.

4. The blanket according to claim 3, wherein the molding surface is a peripheral surface of a mirror-finished metallic cylinder of a calender device.

5. The blanket according to claim 3, wherein the molding surface is a surface of a film having a surface with a very low roughness value.

6. The blanket according to claim 5, wherein the film is on the printing side of the printing layer and provides a protective film.

7. The blanket according to claim 1, wherein the printing layer has a thickness of 0.15 mm to 0.8 mm.

8. The blanket according to claim 1 wherein the printing layer has a dispersive surface energy component between 15 and 30 mJ/m² and a polar surface energy component between 0 and 20 mJ/m².

9. A process for producing the blanket according to claim 1, wherein the printing layer is produced by extrusion or casting of a polymer material in a nip of a calendering device against a molding surface with a very low roughness value.

10. The process according to claim 9, wherein a surface of a mirror-finished cylinder constituting a cylinder of the calendering device is used as the molding surface.

11. The process according to claim 9, wherein a surface of a film with a very low roughness value which is run through the nip of the calendering device is used as the molding surface.

12. The process according to claim 9 wherein the blanket is produced by calendering the printing layer in the nip of the calendering device on a blanket carcass which contains all of the layers except the printing layer.
